(19) United States
(12) Patent Application Publication
(10) Pub. No.: US 2022/0242364 A1
(43) Pub. Date: Aug. 4, 2022

(54) VEHICLE SEATBELT DEVICE

(71) Applicant: HONDA MOTOR CO., LTD., Tokyo (JP)

(72) Inventors: Shinsuke Odai, Wako-shi (JP); Yuji Yasui, Wako-shi (JP); Kenji Komori, Wako-shi (JP); Yosuke Sakamoto, Wako-shi (JP); Yosuke Koike, Wako-shi (JP); Kenshi Torikai, Wako-shi (JP)

(21) Appl. No.: 17/586,823

(22) Filed: Jan. 28, 2022

(30) Foreign Application Priority Data
Feb. 4, 2021 (JP) 2021-016800

(51) Int. Cl. B60R 22/48; B60W 50/14; G06V 20/59; G06V 20/56

(52) U.S. Cl. CPC B60R 22/48; B60W 50/14; B60R 2022/4685; G06V 20/56; G06V 20/597

(57) ABSTRACT

A vehicle seatbelt device of an embodiment includes a seatbelt that restrains a portion of the body of a driver of a vehicle, a tension adjustment mechanism that is able to adjust the tension of the seatbelt, and a controller that controls the tension adjustment mechanism such that the tension of the seatbelt varies in response to a sound emitted by a sound instrument.

### CROSS-REFERENCE TO RELATED APPLICATION

This application is based upon and claims the benefit of priority from Japanese Patent Application No. 2021-016800, filed Feb. 4, 2021, the entire contents of which is incorporated herein by reference.

### BACKGROUND

### Field of the Invention

The present invention relates to a vehicle seatbelt device.

### Description of Related Art

A seatbelt of a vehicle is drawn out from a retractor (a belt winding device) which is fixed to a lower part of a vehicle body pillar and passes through a shoulder belt anchor (which is also referred to as a through ring) which is provided at an upper part of the vehicle body pillar, and then a tip thereof is fastened to a base belt anchor which is fixed to the floor of a vehicle body. The shoulder belt anchor through which the seatbelt passes is positioned on a lateral side of the head of an occupant sitting in a sheet. A technology of installing a speaker in this shoulder belt anchor is known (for example, refer to Japanese Unexamined Patent Application, First Publication No. 2005-119546).

### SUMMARY

In the technologies in the related art, control of the tension of a seatbelt has not been studied from a viewpoint of eliminating tiredness or sleepiness caused by driving, changing mood, and improving pleasure.

The present invention has been made in consideration of such circumstances, and an object thereof is to provide a vehicle seatbelt device capable of eliminating tiredness or sleepiness caused by driving, changing mood, and improving pleasure.

A vehicle seatbelt device according to this invention employs the following constitutions.

(1) A first aspect of the present invention is a vehicle seatbelt device including a seatbelt that restrains a portion of the body of a driver of a vehicle, a tension adjustment mechanism that is able to adjust the tension of the seatbelt, and a controller that controls the tension adjustment mechanism such that the tension of the seatbelt varies in response to a sound emitted by a sound instrument.

(2) According to a second aspect of the present invention, in the first aspect, the vehicle seatbelt device further includes a display that displays an image. The controller changes a mode of a predetermined image displayed by the display in response to the sound.

(3) According to a third aspect of the present invention, in the first or second aspect, the vehicle seatbelt device further includes a recognizer that recognizes circumstances in the vicinity of the vehicle. The controller stops first control of controlling the tension adjustment mechanism such that the tension of the seatbelt varies in response to the sound when the recognizer recognizes an object to be watched carefully by the driver.

(4) According to a fourth aspect of the present invention, in the third aspect, the vehicle seatbelt device further includes a determiner that determines a direction of a visual line or the face of the driver. The controller determines whether or not the driver has directed a visual line or the face to the object recognized by the recognizer on the basis of determination results of the determiner, and starts second control of controlling the tension adjustment mechanism such that the tension of the seatbelt varies in accordance with the object when it is determined that the driver has not directed a visual line or the face to the object.

(5) According to a fifth aspect of the present invention, in the fourth aspect, the vehicle seatbelt device further includes a display that displays an image. The controller causes the display to display a predetermined image when it is determined that the driver has not directed a visual line or the face to the object.

(6) According to a sixth aspect of the present invention, in the second or fifth aspect, the vehicle seatbelt device further includes a determiner that determines a direction of a visual line or the face of the driver. The controller determines whether or not the driver has kept watching the predetermined image displayed by the display over a certain period of time on the basis of determination results of the determiner, and does not cause the display to display the predetermined image when it is determined that the driver has kept watching the predetermined image over a certain period of time, or causes the predetermined image displayed by the display to be blurred when it is determined that the driver has kept watching the predetermined image over a certain period of time compared to when it is determined that the driver has not kept watching the predetermined image over a certain period of time.

According to the foregoing aspects, it is possible to eliminate tiredness or sleepiness caused by driving, change mood, and improving pleasure.

### BRIEF DESCRIPTION OF THE DRAWINGS

FIG. 1 is a view showing an example of a constitution of a vehicle seatbelt device.

FIG. 2 is a view illustrating an example of an inside of a host vehicle M in which a display device is mounted.

FIG. 3 is an explanatory view for a lenticular lens structure of the display device.

FIG. 4 is an explanatory view for a function of the display device.

FIG. 5 is an explanatory view for a relationship between detection of an object by a vehicle exterior camera and display of an image object by the display device.

FIG. 6 is a flowchart showing a flow of a series of processing by a control device according to a first embodiment.

FIG. 7 is a view illustrating a scene in which a host vehicle is traveling in a suburb, an expressway, or the like.

FIG. 8 is an explanatory view for rhythm control.

FIG. 9 is an explanatory view for a control timing of a pretensioner under the rhythm control.

FIG. 10 is a view illustrating a scene in which the host vehicle is traveling in a suburb, an expressway, or the like.

FIG. 11 is an explanatory view for risk notification control.

FIG. 12 is an explanatory view for a control timing of a vibrator under the risk notification control.

FIG. 13 is an explanatory view for a control timing of the pretensioner under the risk notification control.

FIG. 14 is a flowchart showing a flow of a series of processing by the control device according to a second embodiment.

FIG. 15 is a view illustrating a situation in which a personified image becomes blurred under the rhythm control.

FIG. 16 is a view illustrating a situation in which the personified image becomes blurred under the risk notification control.

### DESCRIPTION OF EMBODIMENTS

Hereinafter, embodiments of the present invention will be described with reference to the drawings. In the following embodiments, a case in which regulations for left-hand traffic are applied will be described as an example. However, when regulations for right-hand traffic are applied, the left and right sides may be read in reverse.

### First Embodiment

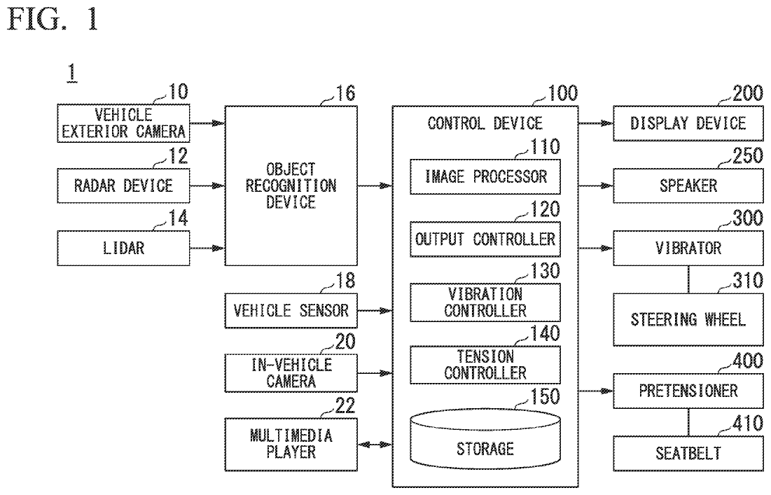

Hereinafter, a first embodiment will be described. FIG. 1 is a view showing an example of a constitution of a vehicle seatbelt device 1. For example, the vehicle seatbelt device 1 includes a vehicle exterior camera 10, a radar device 12, a light detection and ranging (LIDAR) 14, an object recognition device 16, a vehicle sensor 18, an in-vehicle camera 20, a multimedia player 22, a control device 100, a display device 200, a speaker 250, a vibrator 300, a steering wheel 310, a pretensioner 400, and a seatbelt 410. Hereinafter, a vehicle in which the vehicle seatbelt device 1 is mounted will be referred to as a host vehicle M in the description. An instrument in which some or all of the vehicle exterior camera 10, the radar device 12, the LIDAR 14, and the object recognition device 16 are combined is an example of “a recognizer”.

For example, the vehicle exterior camera 10 is a digital camera utilizing a solid-state image capturing element such as a charge coupled device (CCD) or a complementary metal oxide semiconductor (CMOS). The vehicle exterior camera 10 is attached to an arbitrary place in the host vehicle M. The vehicle exterior camera 10 is attached to an upper part of a front windshield, a rear surface of a rear-view mirror, a front head of a vehicle body, or the like. When an image of a side behind the vehicle is captured, the vehicle exterior camera 10 may be attached to an upper part of a rear windshield, a back door, or the like or may be attached to a side mirror or the like.

The radar device 12 radiates radio waves such as millimeter waves to the vicinity of the host vehicle M and detects at least a position (a distance and an azimuth) of an object in the vicinity by detecting radio waves (reflected waves) reflected by the object. The radar device 12 is attached to an arbitrary place in the host vehicle M. The radar device 12 may detect a position and a speed of an object by a frequency modulated continuous wave (FM-CW) method.

The LIDAR 14 emits light to the vicinity of the host vehicle M and measures scattered light. The LIDAR 14 detects a distance to a target on the basis of a time from light emission to light reception. For example, emitted light is pulsed laser light. The LIDAR 14 is attached to an arbitrary place in the host vehicle M.

The object recognition device 16 recognizes a position, a kind, a speed, and the like of an object in the vicinity of the host vehicle M by performing sensor fusion processing with respect to determination results by some or all of the vehicle exterior camera 10, the radar device 12, and the LIDAR 14. Examples of an object include a different vehicle (for example, a peripheral vehicle present within a predetermined distance), a pedestrian, a bicycle, and a road structure. Examples of a road structure include a road sign, a traffic signal, a railroad crossing, a curbstone, a medial divider, a guardrail, and a fence. In addition, examples of a road structure may include a road demarcation line (which will hereinafter be referred to as a demarcation line) and a crosswalk which are painted or adhered on a road surface, and a road surface sign such as a bicycle crossing lane or a stop sign line. In addition, an object may include an obstacle such as a fallen object on a road (for example, a load of a different vehicle or a signboard installed in the vicinity of a road). The object recognition device 16 outputs recognition results to the control device 100. The object recognition device 16 may output determination results of the vehicle exterior camera 10, the radar device 12, and the LIDAR 14 to the control device 100 without any change. In this case, the control device 100 may have functions of the object recognition device 16.

The vehicle sensor 18 includes a vehicle speed sensor for detecting a speed of the host vehicle M, an acceleration sensor for detecting an acceleration, a yaw rate sensor for detecting a yaw rate (for example, a rotation angular speed about a vertical axis passing through a centroidal point of the host vehicle M), an azimuth sensor for detecting a direction of the host vehicle M, and the like. The vehicle sensor 18 outputs signals indicating determination results such as a speed, a virtual degree yaw rate, and an azimuth angle to the control device 100. The vehicle sensor 18 is an example of “a determiner”.

Similar to the vehicle exterior camera 10, for example, the in-vehicle camera 20 is a digital camera utilizing a solid-state image capturing element such as a CCD or a CMOS. For example, the in-vehicle camera 20 is installed in the middle of an instrument panel of the host vehicle M and captures an image of the inside of a compartment. The in-vehicle camera 20 particularly captures an image of a driver of the host vehicle M and an occupant in a passenger seat and outputs the image to the control device 100.

For example, the multimedia player 22 is a digital versatile disc (DVD) reproducing device, a compact disc (CD) reproducing device, a television receiver, a radio broadcast receiver, or the like and is a device for reproducing various kinds of contents such as music, movie, and TV programs. In addition, the multimedia player 22 may be a navigation device having a function of reproducing contents. The multimedia player 22 may be mounted in the host vehicle M or may be a smartphone, a portable digital music player, or the like which has been brought into the vehicle by an occupant (for example, a driver or the like) of the host vehicle M. When the multimedia player 22 is a smartphone, a portable digital music player, or the like, the instrument may perform radio communication with the control device 100. The multimedia player 22 is an example of “a sound instrument”.

For example, the control device 100 includes an image processor 110, an output controller 120, a vibration controller 130, a tension controller 140, and a storage 150. For example, these constituent elements are realized by a hardware processor such as a central processing unit (CPU) executing a program (software). Some or all of these constituent elements may be realized by hardware (a circuit; including circuitry) such as a large scale integration (LSI), an application specific integrated circuit (ASIC), a field-programmable gate array (FPGA), or a graphics processing unit (GPU), or may be realized by software and hardware in cooperation. A program may be stored in the storage 150 in advance or may be stored in an attachable/detachable storage medium (a non-transitory storage medium) such as a DVD or a CD-ROM such that the program is installed in the storage 150 when the storage medium is mounted in a drive device. The output controller 120 and/or the tension controller 140 is an example of “a controller”.

The image processor 110 analyzes an image captured by the in-vehicle camera 20 and detects a direction of a visual line or a direction of the face of an occupant (particularly, a driver) of the host vehicle M. An instrument in which the in-vehicle camera 20 and the image processor 110 are combined is an example of “a determiner”.

The output controller 120 causes the display device 200 to three-dimensionally display a personified image (which will be described below) or the like or causes the speaker 250 to output an audio.

The vibration controller 130 controls the vibrator 300 to cause the steering wheel 310 to vibrate. The tension controller 140 controls the pretensioner 400 to adjust the tension of the seatbelt 410.

For example, the storage 150 is realized by an HDD, a flash memory, an electrically erasable programmable read only memory (EEPROM), a read only memory (ROM), a random-access memory (RAM), or the like. For example, the storage 150 stores a program which is read and executed by the processor.

The display device 200 displays information output by the control device 100 as an image. For example, the display device 200 is a three-dimensional display (a hologram display) such as a looking glass having a lenticular lens structure. The display device 200 is an example of “a display”.

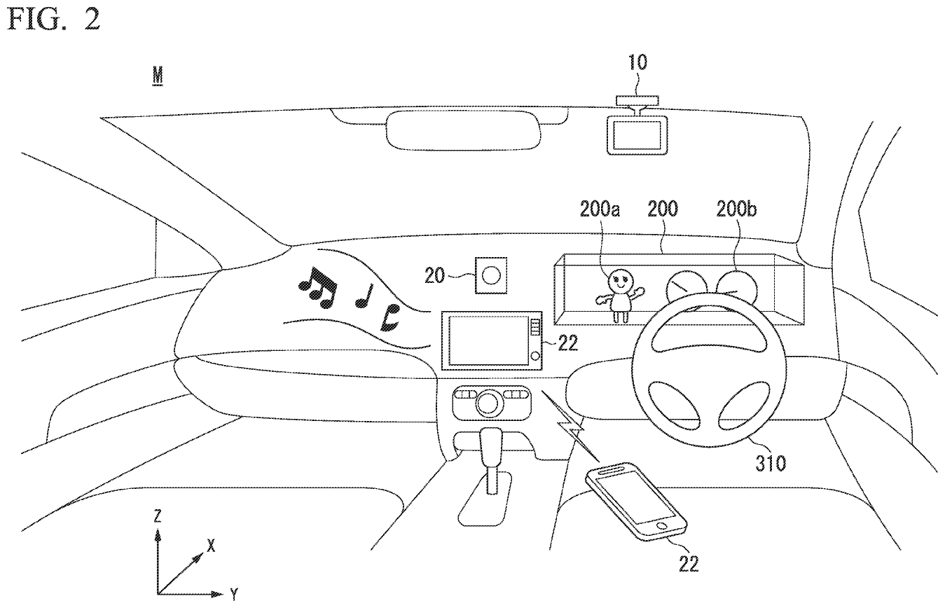

FIG. 2 is a view illustrating an example of an inside of the host vehicle M in which the display device 200 is mounted. As illustrated in FIG. 2, the display device 200 is installed at a position in the instrument panel facing a driver's seat. For example, the display device 200 displays a personified image 200a and a speedometer 200b. A personified image may be an image showing a human, an animal, a plant, a robot, or a different entity which is actually present or may be an image showing a fictional character (a character). Typically, a personified image is an image in which an item personified by animation moves.

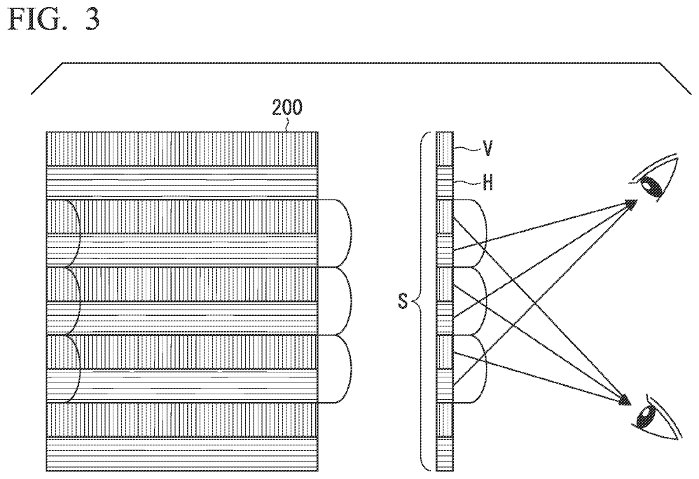

FIG. 3 is an explanatory view for a lenticular lens structure of the display device 200. In FIG. 3, a sheet (a lenticular lens) S in which innumerable micro-dome-shaped convex lenses are arranged is disposed on an image that is referred to as a lenticular image in which images of two kinds such as a vertical line V and a horizontal line H are combined. Since there is a parallax between two eyes of a user, one eye recognizes images of the vertical lines, and the other eye recognizes images of the horizontal lines through the sheet S. Accordingly, a user can recognize an image having a stereoscopic effect.

Description will return to FIG. 1. The speaker 250 outputs information output by the control device 100 as an audio.

The vibrator 300 is embedded inside a portion of a casing such as a rim or a spoke of the steering wheel 310 or is attached to a surface of the casing. Typically, the vibrator 300 is provided one each on both the rim on the left side and the rim on the right side when viewed from the driver.

The steering wheel 310 is an annular component which can adjust steering of the host vehicle M (a forward movement direction). In place of the steering wheel 310, a steering wheel having a different shape that is not an annular shape may be provided or a different operator such as a joystick may be provided in the host vehicle M. In this case, the vibrator 300 may be attached to a steering wheel having a different shape, a joystick, or the like.

The pretensioner 400 includes a mechanism for drawing in (winding) the seatbelt 410 in order to eliminate looseness of the seatbelt 410. The seatbelt 410 is a belt-shaped safety device for restraining the body of an occupant in the seat. For example, the pretensioner 400 intensifies the tension of the seatbelt 410 in stages by means of driving of a motor and operates so as to intensify a restraining force of the seatbelt 410. The pretensioner 400 is an example of “a tension adjustment mechanism”.

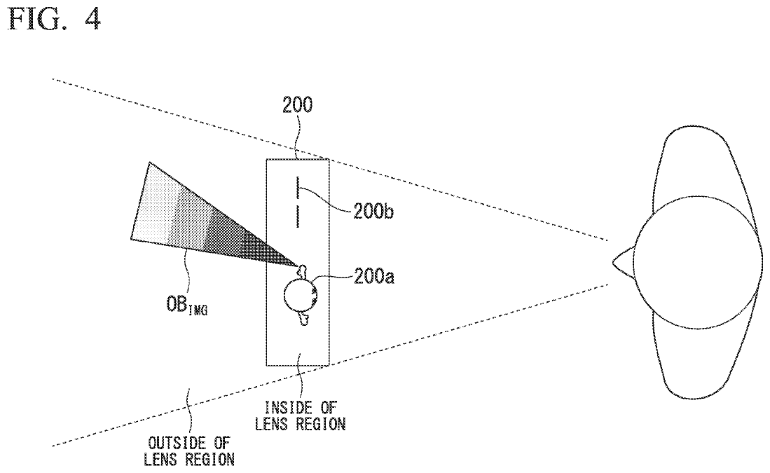

FIG. 4 is an explanatory view for a function of the display device 200. In FIG. 4, in addition to the personified image 200a and the speedometer 200b, the display device 200 continuously displays an image object OB_{IMG} spreading toward a side behind the personified image 200a. For example, the image object OB_{IMG} is displayed in a form of light, sand, or the like. Since the display device 200 can form an image in both the inside of a lens region and the outside of the lens region, a user can three-dimensionally recognize the image object OB_{IMG} spreading from the inside of the lens region toward the outside of the lens region. Meanwhile, the display device 200 also has characteristics in which the visibility of an image formed outside the lens region is inferior to the visibility of an image formed inside the lens region.

In FIG. 4, the display device 200 displays the image object OB_{IMG} in a shape of a continuous group, but a method of displaying the image object OB_{IMG} is not limited thereto. For example, the display device 200 may display the image object OB_{IMG} as a group of a plurality of elements which are intermittently distributed or may display it such that a plurality of elements flow in a certain direction.

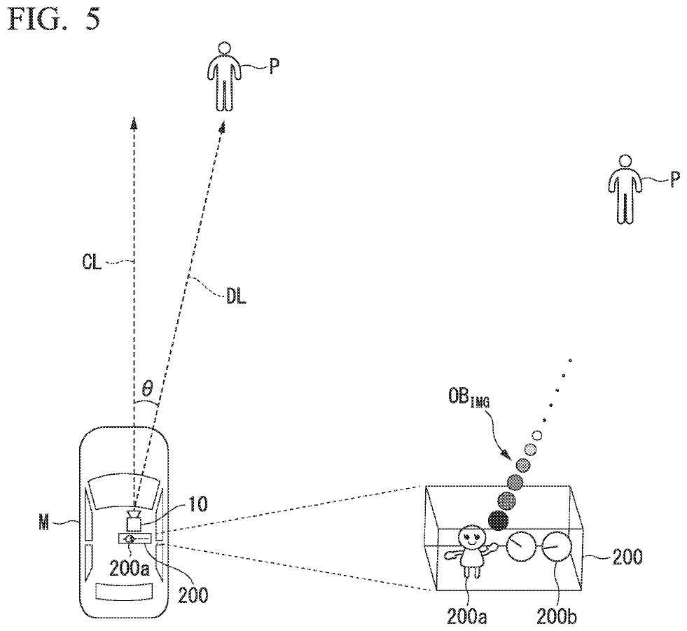

Next, a mechanism of notifying a user of the presence of an object in the vicinity of the host vehicle M using the vehicle exterior camera 10 and the display device 200 will be described. FIG. 5 is an explanatory view for a relationship between detection of an object by the vehicle exterior camera 10 and display of the image object OB_{IMG} by the display device 200. Here, an object present in front of the host vehicle M is detected and a distance and an angle between the host vehicle M and an object are measured exclusively using the vehicle exterior camera 10. In FIG. 5, the reference sign CL indicates an axial direction of the vehicle body of the host vehicle M, the reference sign P indicates a pedestrian, the reference sign DL indicates a distance between the host vehicle M and the pedestrian P, and the reference sign θ indicates an angle of a direction of the pedestrian P with respect to the axial direction CL of the vehicle body. The reference sign P is not limited to a pedestrian and may be a different obstacle such as an automobile or a bicycle.

The object recognition device 16 derives information of the distance DL and the angle θ (information of a height may be further included) by performing position conversion processing from an image-capturing space of the vehicle exterior camera 10 into a plane viewed from the sky. This processing may be performed in the display device 200 or may be performed by the processor which belongs to the vehicle exterior camera 10. The display device 200 acquires information of the distance DL and the angle θ from the object recognition device 16.

The output controller 120 obtains a spatial vector from the personified image 200a to the pedestrian P on the basis of the acquired information of the distance DL and the angle θ and information of the height from the personified image 200a of the display device 200 to the vehicle exterior camera 10. The output controller 120 calculates the direction of the image object OB_{IMG} displayed from a hand side of the personified image 200a toward the position of the pedestrian P on the basis of the obtained spatial vector.

Next, the output controller 120 determines a display mode of the image object OB_{IMG} displayed from the hand side of the personified image 200a toward the position of the pedestrian P on the basis of the determination results of the vehicle exterior camera 10 and the calculated direction of the image object OB_{IMG}. Specifically, the output controller 120 determines a density, a color intensity, a brightness, a size, or the like of the image object OB_{IMG}. The output controller 120 causes the display device 200 to display the image object OB_{IMG} on the basis of the determined display mode. The output controller 120 may change not only the image object OB_{IMG} but also the display mode of the personified image 200a.

In this manner, for example, the output controller 120 causes one or more image objects OB_{IMG} to be continuously displayed in a direction of an obstacle (an obstacle recognized by the object recognition device 16) outside the lens region from the inside of the lens region. In the example of FIG. 5, the position of the pedestrian P is an obstacle recognized by the object recognition device 16. Therefore, the image object OB_{IMG} is displayed toward the position of the pedestrian P.

In FIG. 5, the display device 200 displays the punctiform image object OB_{IMG} from the hand side of the personified image 200a toward the position of the pedestrian P. As described above, since the display device 200 has characteristics in which the visibility of an image formed outside the lens region is inferior to the visibility of an image formed inside the lens region, when the image object OB_{IMG} is displayed in the same mode, inferiority of visibility between the inside of the lens region and the outside of the lens region becomes noticeable so that a user may feel a sense of incompatibility. Hence, when the display device 200 displays one or more image objects OB_{IMG} from the inside of the lens region toward the outside of the lens region, the output controller 120 changes parameters such as a density, a color intensity, a brightness, and/or a size of the image object OB_{IMG} near the lens region compared to the image object OB_{IMG} away from an area near the lens region. For example, in FIG. 5, the output controller 120 causes the punctiform image object OB_{IMG} displayed at a position close to the personified image 200a to be larger than the punctiform image object OB_{IMG} away from the personified image 200a. Moreover, the output controller 120 causes the color of the punctiform image object OB_{IMG} close to the personified image 200a to be darker than the color of the punctiform image object OB_{IMG} away from the personified image 200a. In place of this or in addition to this, the output controller 120 may cause the brightness of the punctiform image object OB_{IMG} close to the personified image 200a to be higher than the brightness of the punctiform image object OB_{IMG} away from the personified image 200a. In addition, in place of this or in addition to this, the output controller 120 may cause the density of the punctiform image object OB_{IMG} close to the personified image 200a to be higher than the density of the punctiform image object OB_{IMG} away from the personified image 200a. In this manner, visual discontinuity of the image object OB_{IMG} can be reduced and a sense of incompatibility of a user can be reduced by determining the display mode such that the density, the color intensity, the brightness, and/or the size of the image object OB_{IMG} near the lens region vary compared to the image object OB_{IMG} away from an area near the lens region.

In the present embodiment, the display device 200 displays the image object OB_{IMG} from the hand side of the personified image 200a, but it is not limited thereto. A start point of the image object OB_{IMG} may be on an inward side or in the vicinity of the personified image 200a instead of the hand side of the personified image 200a.

[Processing Flow of Control Device]

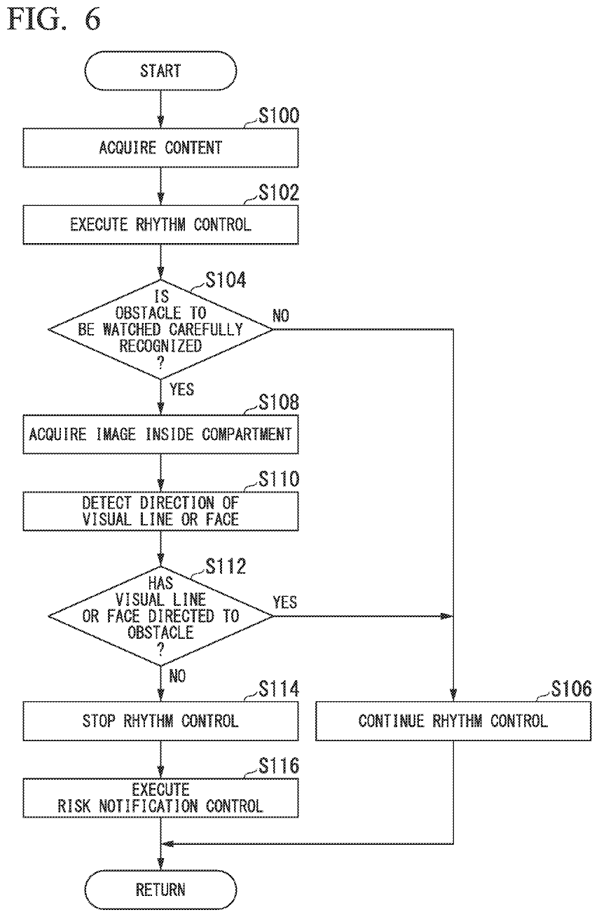

Hereinafter, a series of processing by the control device 100 will be described using a flowchart. FIG. 6 is a flowchart showing a flow of a series of processing by the control device 100 according to the first embodiment. The processing of this flowchart may be repeatedly executed in a predetermined cycle.

First, any constituent element (for example, the output controller 120) of the control device 100 acquires a content to be reproduced by the multimedia player 22 from the multimedia player 22 (for example, music data) (Step S100).

Next, the output controller 120 and the tension controller 140 execute rhythm control in response to a sound of the content acquired from the multimedia player 22 (Step S102). Rhythm control is an example of “first control”.

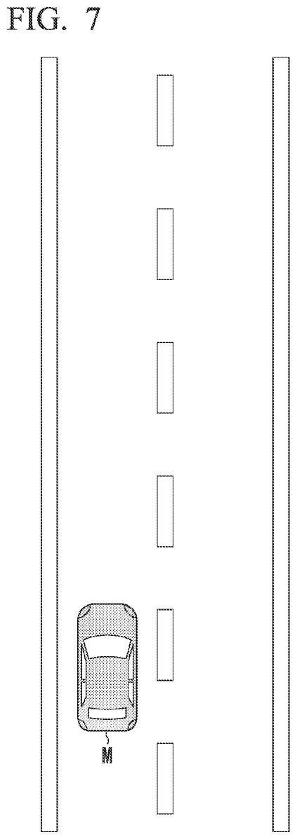

FIG. 7 is a view illustrating a scene in which the host vehicle M is traveling in a suburb, an expressway, or the like. Since there are few other traffic participants, such as pedestrians and bicycles, in a suburb, an expressway, or the like, there are few risk points PT (which will be described below). For example, it is assumed that the driver of the host vehicle M or a passenger therein reproduces a content using the multimedia player 22. In this case, the output controller 120 and the tension controller 140 perform the following control as the rhythm control.

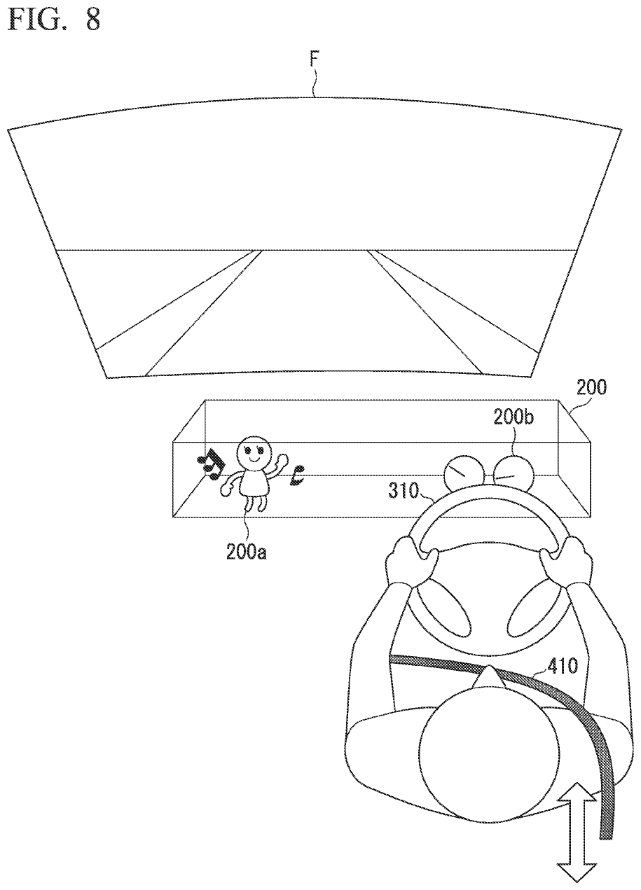

FIG. 8 is an explanatory view for rhythm control. As illustrated in the diagram, in the rhythm control, the output controller 120 causes some or all of the characters displayed as the personified images 200a to be displayed in a manner of moving in response to the sound of the content (or a rhythm thereof) such that the characters are dancing. More specifically, when the content is music, the output controller 120 may cause the characters to move in response to a rhythm of a low-pitched beat or a vibrato of the music, a call of a vocal, or the like. In addition, when the content is a concert, a live show, a comedy, or the like, the output controller 120 may cause the characters to move in response to laughter or applause of spectators.

In the rhythm control, the tension controller 140 controls the pretensioner 400 so as to adjust the tension of the seatbelt 410 in response to a sound of the content (or a rhythm thereof).

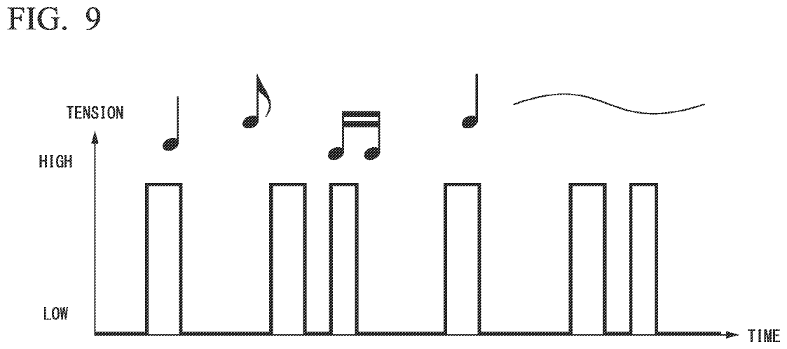

FIG. 9 is an explanatory view for a control timing of the pretensioner 400 under the rhythm control. The tension controller 140 intensifies or weakens the tension of the seatbelt 410 in response to a sound of the content. More specifically, similar to when the characters are moved, when the content is music, the tension controller 140 adjusts the tension of the seatbelt 410 in response to a rhythm of a low-pitched beat or a vibrato of the music, a call of a vocal, or the like. In addition, when the content is a concert, a live show, a comedy, or the like, the tension controller 140 may adjust the tension of the seatbelt 410 in response to laughter or applause of spectators. Moreover, the tension controller 140 may intensify the tension of the seatbelt 410 at a part of hook in the same music source compared to other parts or may weaken the tension of the seatbelt 410 in a quiet music source such as classical music compared to a noisy music source such as heavy metal.

In this manner, a sense of realism can be produced by adjusting the tension of the seatbelt in response to a sound of the content.

Description will return to the flowchart of FIG. 6. Next, the image processor 110 determines whether or not one or a plurality of obstacles to be watched carefully by the driver of the host vehicle M are recognized by the object recognition device 16 (Step S104).

Typically, an obstacle to be watched carefully by the driver is an obstacle which is hidden at a blind spot from the host vehicle M (on a lateral side of, on a rear lateral side of, or behind the host vehicle M), but it is not limited thereto. An obstacle may be an obstacle in front thereof on which the driver has to keep an eye. Hereinafter, an obstacle to be watched carefully by the driver of the host vehicle M will be referred to as “a risk point PT” in the description.

When the risk point PT is not recognized by the object recognition device 16, the output controller 120 and the tension controller 140 continue the rhythm control (Step S106).

Meanwhile, when the risk point PT is recognized by the object recognition device 16, the image processor 110 acquires an image inside the compartment from the in-vehicle camera 20 (Step S108), analyzes the acquired image, and detects the direction of a visual line or the direction of the face of an occupant of (particularly, a driver) of the host vehicle M (Step S110).

Next, the output controller 120 determines whether or not the driver has directed a visual line or the face to the risk point PT on the basis of the determination results of the image processor 110 (Step S112). Hereinafter, directing a visual line or the face to the risk point PT will be referred to as “eye-on”, and not doing so will be referred to as “eye-off” in the description.

For example, the output controller 120 may calculate an angle formed by a vector indicating a direction in which the risk point PT is present and a vector indicating the direction of a visual line or the direction of the face of the driver. It may be determined as eye-on when the formed angle is within an allowable angle, and it may be determined as eye-off when the formed angle is out of the allowable angle. An allowable angle is an angle to the extent that two vectors can be regarded as vectors in the same direction and may be an angle within a range of approximately several degrees to tens of degrees, for example.

When it is determined that the driver has directed a visual line or the face to all of the risk points PT (a case of eye-on), the processing proceeds to S106. Namely, the output controller 120 and the tension controller 140 continue the rhythm control.

Meanwhile, when it is determined that the driver has not directed a visual line or the face to some or all of the risk points PT (a case of eye-off), the output controller 120 and the tension controller 140 stop the rhythm control (Step S114). Further, the output controller 120, the vibration controller 130, and the tension controller 140 execute risk notification control (Step S116). Risk notification control is an example of “second control”.

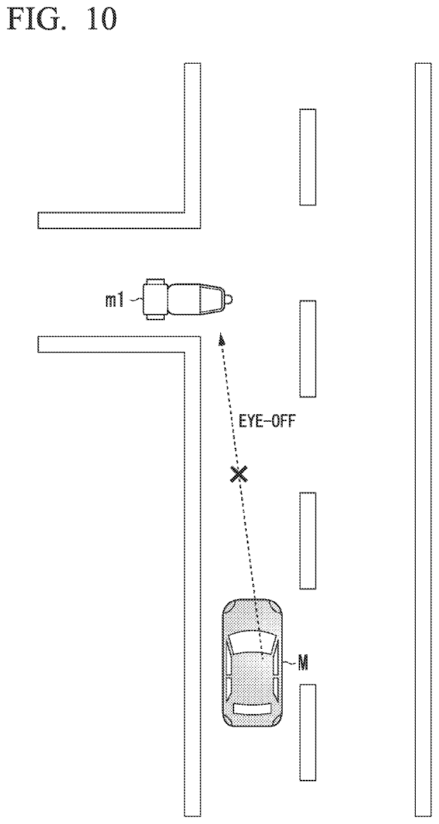

FIG. 10 is a view illustrating a scene in which the host vehicle M is traveling in a suburb, an expressway, or the like. The illustrated scene is a scene in which a motorcycle m1 has appeared unexpectedly in front of the host vehicle M when the host vehicle M is traveling in a suburb, an expressway, or the like. In such a scene, as a matter of course, it is desired for the driver of the host vehicle M to carefully watch the motorcycle m1 which has appeared unexpectedly. Therefore, the output controller 120 regards the motorcycle m1 as the risk point PT and determines whether or not the driver has directed a visual line or the face to the risk point PT. In the illustrated example, the driver has not directed a visual line or the face to the motorcycle m1 (in an eye-off state). In such a case, the output controller 120, the vibration controller 130, and the tension controller 140 perform the following control as the risk notification control.

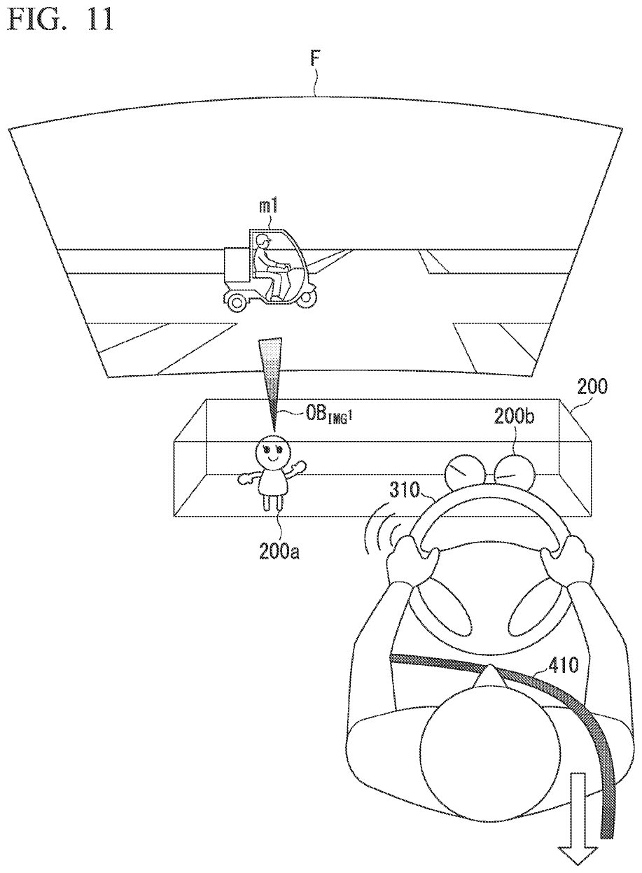

FIG. 11 is an explanatory view for risk notification control. As illustrated in the diagram, in the risk notification control, while pausing a character to be displayed as the personified image 200a, the output controller 120 further causes the image object OB_{IMG} corresponding to the risk point PT (the risk point PT in the eye-off state) to which the driver has not directed a visual line or the face to be displayed around the character. As in the scene of FIG. 10, when the driver has not directed a visual line or the face to the motorcycle m1 (the risk point PT), the output controller 120 causes an image object OB_{IMG}1 indicating a direction in which the motorcycle m1 is present to be displayed by being disposed around the personified image 200a. At this time, the output controller 120 may cause the speaker 250 to output the presence of the motorcycle m1, the direction in which the motorcycle m1 is present, or the like as an audio. The image object OB_{IMG} or a combination of the personified image 200a and the image object OB_{IMG} is an example of “a predetermined image”.

In the risk notification control, the vibration controller 130 controls the vibrator 300 to cause the steering wheel 310 to vibrate. Specifically, when the risk point PT to which the driver has not directed a visual line or the face is present on the left side of the host vehicle M from a viewpoint of the driver, the vibration controller 130 controls the vibrator 300 to cause a part of the steering wheel 310 (the rim, the spoke, or the like) on the left side from a viewpoint of the driver to vibrate more intensively than a part on the right side. On the contrary, when the risk point PT to which the driver has not directed a visual line or the face is present on the right side of the host vehicle M from a viewpoint of the driver, the vibration controller 130 controls the vibrator 300 to cause a part of the steering wheel 310 on the right side from a viewpoint of the driver to vibrate more intensively than a part on the left side. Accordingly, the driver of the host vehicle M can be notified of the presence of an obstacle which is not recognized by the driver. As a result, safety of the driver of the host vehicle M and an area around the host vehicle M can be further improved.

In the scene of FIG. 10, since the motorcycle m1 is present in front on the left side of the host vehicle M from a viewpoint of the driver, the vibration controller 130 causes a part of the steering wheel 310 on the left side to vibrate and does not cause a part of the steering wheel 310 on the right side to vibrate. Even if a part of the steering wheel 310 on the right side is not caused to actively vibrate, vibration at a part on the left side may be transferred thereto so that a part on the right side may passively vibrate. Even in such a case, in consideration of attenuation in vibration, vibration becomes more intensified at a part on the left side than at least a part on the right side.

In the risk notification control, the tension controller 140 controls the pretensioner 400 to adjust the tension of the seatbelt 410. Specifically, when the driver has not directed a visual line or the face to a certain risk point PT, the tension controller 140 may intensify the tension of the seatbelt 410 compared to when the driver has directed a visual line or the face to the risk point PT. Namely, the tension of the seatbelt 410 adjusted by the risk notification control may be more intensified than the tension of the seatbelt 410 adjusted by the rhythm control.

In addition, when the risk point PT to which the driver has not directed a visual line or the face is present behind the host vehicle M from a viewpoint of the driver, the tension controller 140 may intensify the tension of the seatbelt 410 compared to when the risk point PT is present in front of the host vehicle M from a viewpoint of the driver.

In the scene of FIG. 10, since the motorcycle m1 is present in front on the left side of the host vehicle M from a viewpoint of the driver, the tension controller 140 may further intensify the tension of the seatbelt 410 than that at the time of the rhythm control while further weakening the tension of the seatbelt 410 than when it is present behind. Accordingly, when there is a high likelihood that the driver has not visually recognized the risk point PT, the driver is more intensively restrained in the seat. As a result, the driver of the host vehicle M can be notified of the presence of an obstacle which is not recognized by the driver, and thus safety of the driver of the host vehicle M and an area around the host vehicle M can be further improved.

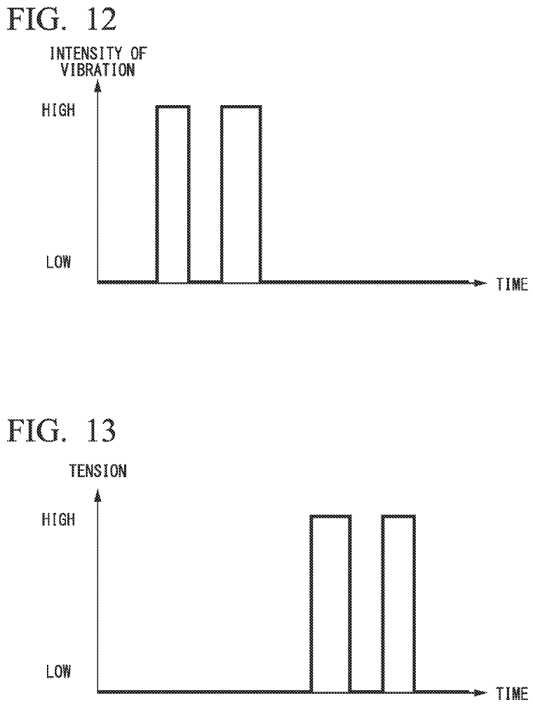

FIG. 12 is an explanatory view for a control timing of the vibrator 300 under the risk notification control. FIG. 13 is an explanatory view for a control timing of the pretensioner 400 under the risk notification control. First of all, the vibration controller 130 controls the vibrator 300 to cause the steering wheel 310 to vibrate. For example, the vibration controller 130 may cause the steering wheel 310 to vibrate twice. After the steering wheel 310 has vibrated, the tension controller 140 controls the pretensioner 400 to intensify the tension of the seatbelt 410. Similar to those described above, the tension controller 140 may intensify the tension such that the seatbelt 410 is pulled twice. The number of vibrations in the steering wheel 310 and the number of pulls of the seatbelt 410 are not limited to twice, and they may be once or may be three times or more. In addition, the tension controller 140 may not only intermittently pull the seatbelt 410 but may also be continuously (regularly) pull the seatbelt 410.

In this manner, since the seatbelt 410 is pulled after the steering wheel 310 is caused to vibrate with a time difference therebetween, it is possible to more intensively call driver's attention to that the risk point PT is present in the vicinity of the host vehicle M. A timing for vibrating the steering wheel 310 and a timing for pulling the seatbelt 410 may be the same, or the steering wheel 310 may be caused to vibrate after the seatbelt 410 is pulled.

According to the first embodiment described above, the vehicle seatbelt device 1 includes the seatbelt 410 that restrains a portion of the body of a driver of the host vehicle M, the pretensioner 400 (an example of the tension adjustment mechanism) that is able to adjust the tension of the seatbelt 410, and the tension controller 140 that controls the pretensioner 400 such that the tension of the seatbelt 410 varies in response to a sound of a content reproduced by the multimedia player 22 (an example of the sound instrument). Accordingly, it is possible to eliminate tiredness or sleepiness caused by driving, change mood, and improve pleasure.

### Modification Example of First Embodiment

In the first embodiment described above, it has been described that when the risk point PT is recognized while the rhythm control is executed and the driver has not directed a visual line or the face to the risk point PT, the control device 100 stops the rhythm control and starts the risk notification control. The risk notification control includes causing the display device 200 to display the personified image 200a or the image object OB_{IMG}, causing the steering wheel 310 to vibrate, and pulling the seatbelt 410. The risk notification control may further include controlling the multimedia player 22.

For example, in the risk notification control, the output controller 120 may instruct the multimedia player 22 to suspend reproduction of a content, instruct it to reduce a volume, or instruct it to reproduce a predetermined content for calling attention to. Accordingly, for example, since a lively space with music changes to a quiet space, the driver can instantly recognize that the risk point PT is present.

FIG. 8 is an explanatory view for the rhythm control. As illustrated in the diagram, in the rhythm control, the output controller 120 causes some or all of the characters displayed as the personified images 200a to be displayed in a manner of moving in response to a sound of the content (or a rhythm thereof) such that the characters are dancing. More specifically, when the content is music, the output controller 120 may cause the characters to move in response to a rhythm of a low-pitched beat or a vibrato of the music, a call of a vocal, or the like. In addition, when the content is a concert, a live show, a comedy, or the like, the output controller 120 may cause the characters to move in response to laughter or applause of spectators.

In the rhythm control, the tension controller 140 controls the pretensioner 400 so as to adjust the tension of the seatbelt 410 in response to a sound of the content (or a rhythm thereof).

FIG. 9 is an explanatory view for a control timing of the pretensioner 400 under the rhythm control. The tension controller 140 intensifies or weakens the tension of the seatbelt 410 in response to a sound of the content. More specifically, similar to when the characters are moved, when the content is music, the tension controller 140 adjusts the tension of the seatbelt 410 in response to a rhythm of a low-pitched beat or a vibrato of the music, a call of a vocal, or the like. In addition, when the content is a concert, a live show, a comedy, or the like, the tension controller 140 may adjust the tension of the seatbelt 410 in response to laughter or applause of spectators. Moreover, the tension controller 140 may intensify the tension of the seatbelt 410 at a part of hook in the same music source compared to other parts or may weaken the tension of the seatbelt 410 in a quiet music source such as classical music compared to a noisy music source such as heavy metal.

In addition, in the first embodiment described above, it has been described that in the rhythm control, a character displayed as the personified image 200a is moved or the tension of the seatbelt 410 is adjusted in response to a sound of the content (for example, a low-pitched beat of a music source), but it is not limited thereto.

For example, when a content reproduced by the multimedia player 22 is acquired from the multimedia player 22, the control device 100 may download preset data for the rhythm control from a dedicated server or the like via an Internet line such as Web. For example, when the content is a music source, preset data is a data set in which motion patterns for the characters and/or adjustment patterns for the tension of the seatbelt 410 associated with respective pieces of music are set in advance.

For example, the output controller 120 may cause some or all of the characters displayed as the personified images 200a to move in accordance with the downloaded motion pattern of the preset data. Similarly, the tension controller 140 may adjust the tension of the seatbelt 410 in accordance with the downloaded adjustment pattern of the preset data. In this manner, when the rhythm control is performed on the basis of preset data in which a motion method for the characters and an adjustment method for the tension of the seatbelt 410 have been patterned, a processing time can be further shortened than when a content is analyzed in real time and the rhythm control is performed. As a result, a response speed at the time of moving a character and a response speed at the time of pulling the seatbelt 410 become faster, and thus a sense of realism can be enhanced.

### Second Embodiment

Hereinafter, a second embodiment will be described. The second embodiment differs from the first embodiment described above in that in the rhythm control or the risk notification control, when a driver has kept watching the personified image 200a (a character) displayed by the display device 200 over a certain period of time, the display mode of the personified image 200a varies. Hereinafter, points different from the first embodiment will be mainly described, and description for points common to the first embodiment will be omitted. In the description of the second embodiment, a description will be provided with the same reference signs applied to the same parts of the first embodiment.

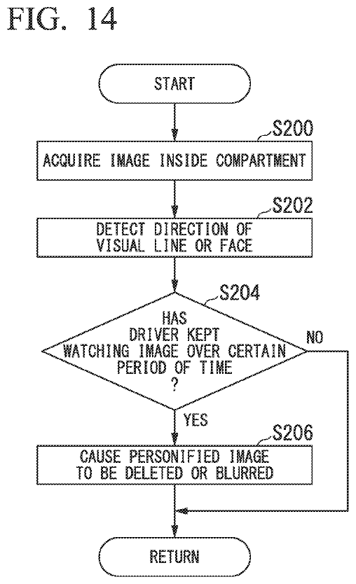

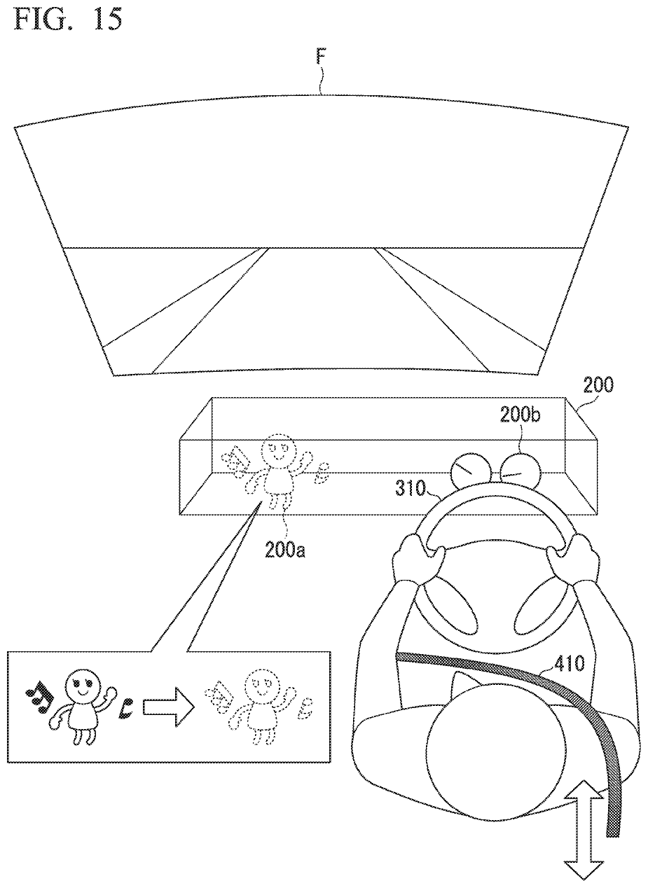

FIG. 14 is a flowchart showing a flow of a series of processing by the control device 100 according to the second embodiment. The processing of this flowchart may be repeatedly executed in a predetermined cycle when the rhythm control or the risk notification control is executed.

First, the image processor 110 acquires an image inside the compartment from the in-vehicle camera 20 (Step S200), analyzes the acquired image, and detects the direction of a visual line or the direction of the face of a driver of the host vehicle M (Step S202).

Next, the output controller 120 determines whether or not the driver has kept watching the personified image 200a over a certain period of time on the basis of the determination results of the image processor 110 (Step S204).

When the driver has not kept watching the personified image 200a over a certain period of time, the output controller 120 ends the processing of this flowchart.

Meanwhile, when the driver has kept watching the personified image 200a over a certain period of time, the output controller 120 deletes the personified image 200a or causes the personified image 200a to be blurred (to be transparent) (Step S206).

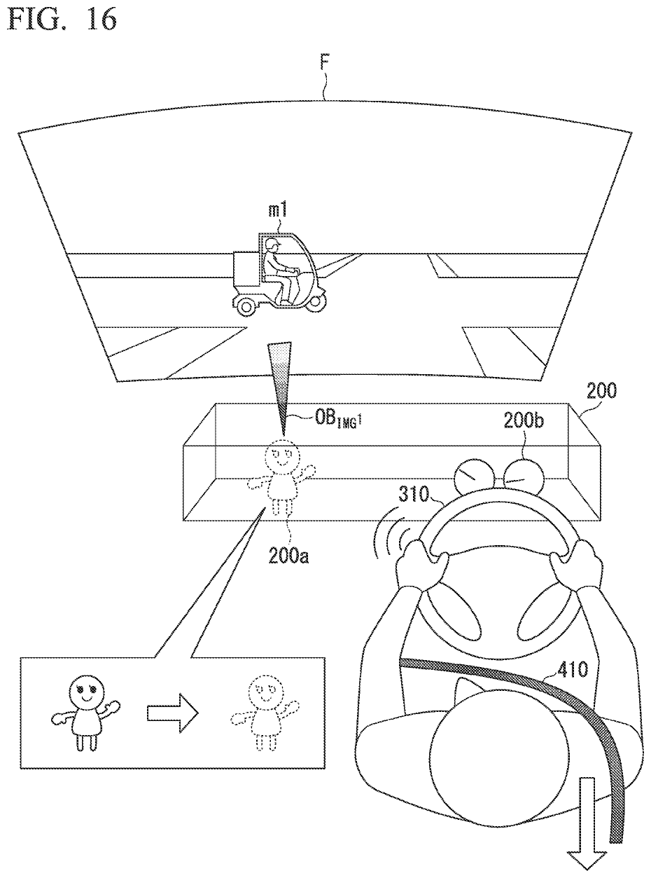

FIG. 15 is a view illustrating a situation in which the personified image 200a becomes blurred under the rhythm control. FIG. 16 is a view illustrating a situation in which the personified image 200a becomes blurred under the risk notification control. When the personified image 200a is displayed by the display device 200, it is postulated that the driver carefully watches the personified image 200a so that realization of the risk point PT may be delayed. Particularly, under the rhythm control, since the personified image 200a is displayed such that the character is dancing, driver's attention is easily attracted.

Therefore, when the driver has kept watching the personified image 200a over a certain period of time, the output controller 120 causes the personified image 200a to be blurred (to be transparent) compared to when the driver has not kept watching the personified image 200a over a certain period of time. At this time, the output controller 120 may cause the personified image 200a to be more blurred when the time during which the driver has kept watching the personified image 200a becomes longer. In addition, the output controller 120 may cause the personified image 200a to be completely transparent and may not cause the personified image 200a to be displayed.

According to the second embodiment described above, when the driver has kept watching the personified image 200a (a character) over a certain period of time, the personified image 200a is caused to be deleted or blurred. Therefore, oversight of the risk point PT and the like can be curbed. As a result, safety can be enhanced.

Hereinabove, forms for performing the present invention have been described using the embodiments, but the present invention is not limited to the embodiments in any way. Various modifications and replacements can be added within a range not departing from the gist of the present invention.

What is claimed is:

1. A vehicle seatbelt device comprising:
a seatbelt that restrains a portion of the body of a driver of a vehicle;
a tension adjustment mechanism that is able to adjust a tension of the seatbelt; and
a controller that controls the tension adjustment mechanism such that a tension of the seatbelt varies in response to a sound emitted by a sound instrument.

2. The vehicle seatbelt device according to claim 1 further comprising:
a display that displays an image,
wherein the controller changes a mode of a predetermined image displayed by the display in response to the sound.

3. The vehicle seatbelt device according to claim 1 further comprising:
a recognizer that recognizes circumstances in the vicinity of the vehicle,
wherein the controller stops first control of controlling the tension adjustment mechanism such that a tension of the seatbelt varies in response to the sound when the recognizer recognizes an object to be watched carefully by the driver.

4. The vehicle seatbelt device according to claim 3 further comprising:
a determiner that determines a direction of a visual line or the face of the driver,
wherein the controller
determines whether or not the driver has directed a visual line or the face to the object recognized by the recognizer on the basis of determination results of the determiner, and
starts second control of controlling the tension adjustment mechanism such that a tension of the seatbelt varies in accordance with the object when it is determined that the driver has not directed a visual line or the face to the object.

5. The vehicle seatbelt device according to claim 4 further comprising:
a display that displays an image,
wherein the controller causes the display to display a predetermined image when it is determined that the driver has not directed a visual line or the face to the object.

6. The vehicle seatbelt device according to claim 2 further comprising:
a determiner that determines a direction of a visual line or the face of the driver,
wherein the controller
determines whether or not the driver has kept watching the predetermined image displayed by the display over a certain period of time on the basis of determination results of the determiner, and
does not cause the display to display the predetermined image when it is determined that the driver has kept watching the predetermined image over a certain period of time, or
causes the predetermined image displayed by the display to be blurred when it is determined that the driver has kept watching the predetermined image over a certain period of time compared to when it is determined that the driver has not kept watching the predetermined image over a certain period of time.
